(19) United States
(12) Patent Application Publication
(10) Pub. No.: US 2017/0063105 A1
(43) Pub. Date: Mar. 2, 2017

(54) CHARGING METHOD, CHARGING CONTROLLER AND CHARGING SYSTEM

(71) Applicant: NUVOTON TECHNOLOGY CORPORATION, HSINCHU CITY (TW)

(72) Inventors: Ping-Ying CHU, HSINCHU CITY (TW); Ling-Jia CHEN, HSINCHU CITY (TW)

(21) Appl. No.: 15/233,218

(22) Filed: Aug. 10, 2016

(30) Foreign Application Priority Data
Aug. 27, 2015 (TW) 104128087

(51) Int. Cl. H02J 7/00

(52) U.S. Cl. CPC H02J 7/007; H02J 7/0029; H02J 2007/0096; H02J 2007/0037; H02J 2007/0039

(57) ABSTRACT

A charging method, a charging controller and a charging system are provided. The method includes the following steps: when a power receiving device is charged by a charging device through a transmission cable with a charging voltage, a current passing through a battery charging circuit is detected by a sensor. The charging information associated with the current is sent to a transmission module of the power receiving device through a monitoring program, and then the charging information is sent back to the charging device by the transmission module through the communication channel of the transmission cable. The transmission module of the charging device determines whether the charging information is satisfied with the stop condition. If so, the charging voltage is maintained to charge the power receiving device continuously. If not, the output charging voltage is gradually adjusted until the stop condition is satisfied.

### CROSS-REFERENCE TO RELATED APPLICATION

This application claims the benefit of Taiwan Patent Application No. 104128087, filed on Aug. 27, 2015, in the Taiwan Intellectual Property Office, the disclosure of which is incorporated herein in its entirety by reference.

### BACKGROUND OF THE INVENTION

1. Field of the Invention

The present disclosure generally relates to a charging method, a charging controller and a charging system, in particular to the charging method, the charging controller and the charging system adapted to various chargeable electronic devices and transmission cables. By means of adjusting the output voltage, the charging method, the charging controller and the charging system enable the electronic device to receive the optimal charging current in the charging process so as to shorten the charging period.

2. Description of the Related Art

The mobile devices such as smartphones, tablets, and so on have been broadly popularized, but these wireless devices are mainly supported with power by the battery while not being connected with power wires. When the mobile device is powered by the built-in battery, the battery performance affects the functioning time greatly. So, the charging method plays the crucial role in the convenience of the usage of the mobile device. Because functions of the mobile device have been updating, the requirements of the power consumption for the display screen, processor, and so on are increased accordingly. As a consequence, how to design a better charging method to provide the necessary power to the mobile devices from the peripheral device is an urgent need.

Conventionally, the charging method is to use a universal serial bus (USB) line to connect the mobile device with a charger, and then the charger supplies the mobile device with a fixed output voltage for charging. The mobile devices have respective current capacities, whereas the regular charger is designed to provide the mobile device with a fixed output voltage in a predetermined safety value. The received current of the mobile device proportionates to the received voltage, meaning that the higher voltage the charger supplies, the greater charging current the mobile device receives and the shorter charging period it takes. As a consequence, some chargers (such as car charger) may be built in regulators to compensate the voltage loss resulted from the impedance of the cable. However, it is hard for the USB charger to predict the impedances of the charging wire connected thereto, meaning that if the USB charger is provided with overhigh charging voltage for compensation, the overcharge current caused by the overhigh voltage may damage the charged mobile device.

As a result, in addition to adjusting the safety value of the charging voltage, the inventor of the present disclosure has been mulling it over and accordingly designs a charging method, a charging controller and a charging system which aim at resolving the existing shortcomings so as to promote the industrial practicability.

### SUMMARY OF THE INVENTION

In view of the aforementioned technical problems, one objective of the present disclosure is to provide a charging method, a charging controller and a charging system to resolve the technical problems concerning that the conventional charger only provides the fixed charging voltage and fails to predict the type of the transmission cable of the charger, such that the higher charging current is provided to shorten the charging period.

In accordance with one objective of the present disclosure, a charging method adapted to a charging device and a power receiving device is provided. The power receiving device may be connected to the charging device by a transmission cable, and the charging device may use a first transmission module to control an output voltage control circuit to output a charging voltage to charge the power receiving device through the transmission cable. The charging method includes the following steps: (a). when the charging voltage is transmitted to a battery charging circuit, detecting a current passing through the battery charging circuit by a sensor (sensing module) of the power receiving device; (b). transmitting charging information associated with the current to a second transmission module of the power receiving device by a monitoring program of the power receiving device; (c). transmitting the charging information associated with the current to the first transmission module by the second transmission module through a communication channel of the transmission cable; (d). determining whether the charging information is satisfied with a stop condition by the first transmission module, when the stop condition is satisfied, maintaining the charging voltage to continue charging the power receiving device, and if not, executing step (e); and (e). adjusting the charging voltage outputted from the output voltage control circuit and returning to step (a) until the stop condition is satisfied.

Preferably, the stop condition means that the charging voltage outputted from the output voltage control circuit reaches to an output voltage safety value.

Preferably, the stop condition means that the current passing through the battery charging circuit is not increased correspondingly after the charging voltage is boosted.

Preferably, the sensor may further sense a voltage inputted to the battery charging circuit, and information associated with the voltage may be transmitted to the second transmission module by the monitoring program and to the first transmission module through the communication channel.

Preferably, the stop condition means that when the voltage reaches to an input voltage safety value.

Preferably, the charging information may be transmitted or received between the first transmission module and the second transmission module via a vender defined message packet.

In accordance with another objective of the present disclosure, a charging controller is provided, which is connected to an output voltage control circuit. The output voltage control circuit may be connected to a power receiving device through a transmission cable and configured to output a charging voltage to charge the power receiving device through the transmission cable. The charging controller includes a transmission module connected to the power receiving device by the transmission cable and configured to receive charging information transmitted from the power receiving device through a communication channel, and a determination module connected to the transmission module, and configured to determine whether the charging information is satisfied with a stop condition, if the stop condition is satisfied, maintaining the charging voltage to continue charging the power receiving device, and if not, gradually adjusting the charging voltage outputted from the output voltage control circuit until the stop condition is satisfied.

Preferably, the stop condition means that the charging voltage reaches to an output voltage safety value.

Preferably, the charging information may include a current passing through the power receiving device, and the stop condition means that the current passing through the power receiving device is not boosted correspondingly after the charging voltage is boosted.

Preferably, the charging information may include a voltage inputted to the power receiving device, and the stop condition means that the voltage reaches to an input voltage safety value.

In accordance with yet another objective of the present disclosure, a charging system is provided, which may include a charging device and a power receiving device. The charging device may include a first transmission module disposed in the charging device, and an output voltage control circuit connected to the first transmission module, and the first transmission module is configured to control the output voltage control circuit to provide a charging voltage. The power receiving device may be connected to the charging device through a transmission cable, and may include: a battery charging circuit connected to the output voltage control circuit by the transmission cable and configured to receive the charging voltage to charge the power receiving device; a sensor (sensing module) connected to the battery charging circuit, sensing a current passing through the battery charging circuit, and a second transmission module disposed in the power receiving device and connected to the first transmission module by the transmission cable, configured to transmit charging information associated with the current to the second transmission module by a monitoring program and to the first transmission module through a communication channel of the transmission cable. Wherein, the first transmission module determines whether the charging information is satisfied with a stop condition; if the stop condition is satisfied, the charging voltage is maintained to continue charging the power receiving device, and if not, the charging voltage outputted from the output voltage control circuit is gradually adjusted until the stop condition is satisfied.

Preferably, the stop condition means that the charging voltage reaches to an output voltage safety value.

Preferably, the stop condition means that the current passing through the battery charging circuit is not boosted correspondingly after the charging voltage is boosted.

Preferably, the sensor may further sense a voltage inputted to the battery charging circuit and information associated with the voltage may be transmitted to the second transmission module by the monitoring program and to the first transmission module through the communication channel.

Preferably, the stop condition means that the voltage reaches to an input voltage safety value.

Preferably, the charging information may be transmitted or received between the first transmission module and the second transmission module via a vender defined message packet.

As mentioned previously, the charging method, the charging controller and the charging system of the present disclosure may have one or more advantages as follows.

1. The charging method, the charging controller and the charging system of the present disclosure facilitate the charging device to adjust the outputted charging voltage, so that the power receiving device can receive the maximum output current, and the charging period is therefore shortened.

2. The charging method, the charging controller and the charging system of the present disclosure apply the method of adjusting the charging voltage to the system program or application without any other hardware or periphery components to achieve the optimal charging manner and reduce the manufacturing cost.

3. The charging method, the charging controller and the charging system of the present disclosure can be applied to automatically adjust the charging voltage by the charging mechanism without manual adjustment, so that the practicability of the convenience and usage of mobile devices are promoted greatly.

### BRIEF DESCRIPTION OF THE DRAWINGS

FIG. 1 is a schematic diagram of one embodiment of a charging system of the present disclosure.

FIG. 2 is a flow chart of one embodiment of a charging method of the present disclosure.

FIG. 3 is a schematic diagram of an embodiment of a charging controller of the present disclosure.

FIG. 4 is a flow chart of another embodiment of a charging method of the present disclosure.

FIG. 5 is a schematic diagram of another embodiment of a charging system of the present disclosure.

### DETAILED DESCRIPTION OF THE PREFERRED EMBODIMENTS

In order to facilitate the understanding of the technical features, the contents and the advantages of the present disclosure, and the effectiveness thereof that can be achieved, the present disclosure will be illustrated in detail below through embodiments with reference to the accompanying drawings. On the other hand, the diagrams used herein are merely intended to be schematic and auxiliary to the specification, but are not necessary to be true scale and precise configuration after implementing the present disclosure. Thus, it should not be interpreted in accordance with the scale and the configuration of the accompanying drawings to limit the scope of the present disclosure on the practical implementation.

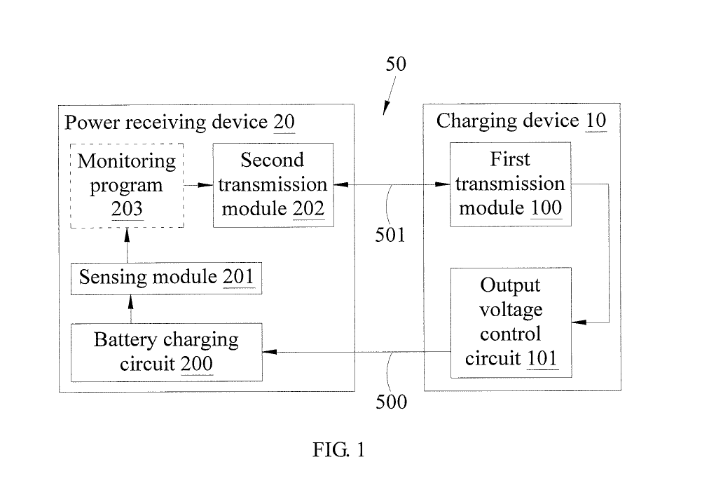

Please refer to FIG. 1 which is a schematic diagram of one embodiment of a charging system of the present disclosure. As shown in the figure, a charging system includes a charging device 10 and a power receiving device 20. The charging device 10 may be a charging base connected a power supply socket, a mobile power charger including a supplying cell or an electronic device including transmission ports such as desk computer, laptop and so on. Devices, which are capable of outputting voltage to charge through the transmission port, are all included in the charging device 10 of the present disclosure. The charging device 10 includes a first transmission module 100 disposed inside the charging device 10 and connected to an output voltage control circuit 101. The first transmission module 100 may be a control chip or circuit which adjusts an output voltage value outputted from the output voltage control circuit 101 by the first transmission module 100. The adjustment mentioned herein means that the first transmission module 100 transmits the information associated with the received current or voltage to the software program of the charging device 10. For example, the power-management program installed in the computer is applied to transmit a control instruction to the output voltage control circuit 101 to boost the output voltage. Alternatively, a charging algorithm can be installed in the first transmission module 100 such as adding an identification mechanism to the chip of mobile power charger; so that it can adjust the output voltage control circuit 101 according to the control signal generated corresponding to the received information when receiving the information associated with the current or voltage. The charging device 10 is disposed with a predetermined charging voltage. For example, when charging a smartphone, the output voltage can be predetermined as 4.5V or 5V. The predetermined charging voltage is set based on the type of the charging device 10.

Please refer to FIG. 1 again. The charging system further includes the power receiving device 20 which may be the electronic devices such as a smartphone, a tablet, a portable game console, and notebook, and so on. The power receiving device 20 includes a rechargeable battery for charging the aforementioned devices. The power receiving device 20 and the charging device 10 are connected to each other by a transmission cable 50. The transmission cable 50 mentioned herein may be a universal serial bus (USB) transmission cable, but it shall be not limited thereto. Any transmission cables, which have a communication channel capable of transmitting power and data, are included in the present disclosure. The power receiving device 20 includes a battery charging circuit 200, a sensing module 201 and a second transmission module 202. The battery charging circuit 200 and the output voltage control circuit 101 of the charging device 10 are respectively connected to the port of the transmission cable 50 such as the contact of Voltage bus (Vbus) of USB. By means of connecting with a power channel 500 of the transmission cable 50, the charging voltage provided by the output voltage control circuit 101 is transmitted to enable the battery charging circuit 200 to charge the rechargeable battery of the power receiving device 20.

The predetermined charging voltage of the conventional charging device 10 is unchangeable. As far as the user is concerned, the used transmission cable 50 has various internal resistances, and therefore, the power receiving device 20 receives different voltage values, causing that the currents inputted to the battery charging circuit 200 are different. In view of this, the power receiving device 20 applies the built-in sensing module 201 to sense a current passing through the battery charging circuit 200 and then to transmit charging information associated with the current to a monitoring program 203 of the power receiving device 20. Afterward, the monitoring program 203 transmits the charging information associated with the current to the second transmission module 202. The sensing module 201 mentioned herein, which may be an extra voltage or current detector or sensor, or the circuit elements combined with the battery charging circuit 200, is applied to sense the condition of the current passing through the battery charging circuit 200. The second transmission module 202 and the first transmission module 100 are connected to each other through a communication channel 501 of the transmission cable 50 to detect the charging information associated with the current. After receiving the actual information associated with the current, the first transmission module 100 determines whether the current passing through the battery charging circuit 200 is the optimal value according to the charging mechanism built based on the hardware setting or the software program. If it fails to satisfy with the optimal value, the output voltage control circuit 101 is adjusted to compensate the charging voltage. For example, the predetermined charging voltage is gradually boosted to an adjusted charging voltage, enabling the boosted voltage to compensate the loss of the voltage resulted from the impedance of the transmission cable 50, and the battery charging circuit 200 therefore obtains a higher current passing through to shorten the charging period. The adjustment will be detailed in the embodiment of the method of the present disclosure.

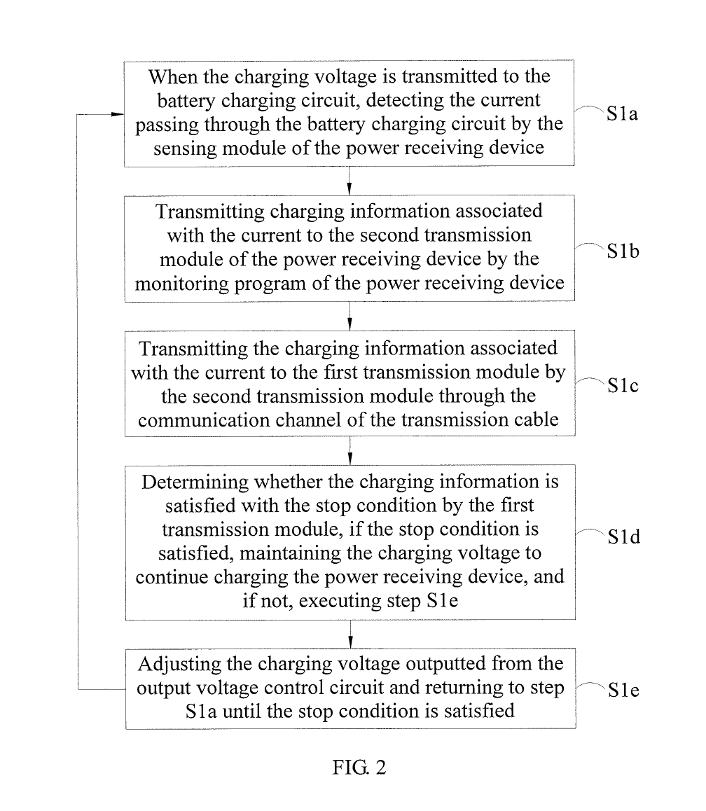

Please refer to FIG. 2 which is a flow chart of one embodiment of a charging method of the present disclosure. The charging method adapts to the charging device and the power receiving device mentioned in the foregoing embodiment. The power receiving device is connected to the charging device by the transmission cable, the first transmission module of the charging device controls the output voltage control circuit, and the output voltage charges the power receiving device. As shown in the figure, the charging method includes the following steps:

Step S1a: when the charging voltage is transmitted to the battery charging circuit, detecting the current passing through the battery charging circuit by the sensing module of the power receiving device;

Step S1b: transmitting charging information associated with the current to the second transmission module of the power receiving device by the monitoring program of the power receiving device;

Step S1c: transmitting the charging information associated with the current to the first transmission module by the second transmission module through the communication channel of the transmission cable;

Step S1d: determining whether the charging information is satisfied with the stop condition by the first transmission module, if the stop condition is satisfied, maintaining the charging voltage to continue charging the power receiving device, and if not, executing step S1e; and

Step S1e: adjusting the charging voltage outputted from the output voltage control circuit and returning to step S1a until the stop condition is satisfied.

Regarding step S1a, most conventional mobile devices are disposed with the chip which is capable of calculating and processing, and thus, the internal substrate is usually disposed with the detecting circuit for detecting whether the mobile device is overcharged, such that it can prevent the components from overcharging or overheating to cause damage. By means of the built-in detecting circuit, it can detect the current really passing through the battery charging circuit so as to obtain the current magnitude which is really inputted to the charging device. In step S1b, when the value of the current really passing through the battery charging circuit is detected, the detected current value is transmitted to the monitoring program installed in the mobile device, and then the monitoring program is applied to monitor the charging current. The monitoring program mentioned herein is not subject to the application (APP) which is downloaded randomly by the user. The monitoring program may be an applied program service which is installed in the mobile device in advance or the processing program built-in the operating system. And alternatively, the monitoring program is a part of the driving program of the mobile device. Any monitoring programs, which are capable of obtaining the real monitor value of the battery charging circuit and transmitting the obtained value to the second transmission module, are served as the monitoring program applied in the present disclosure.

In step S1c, the second transmission module receives the charging information associated with the current really passing through the battery charging circuit, and the information is transmitted to the charging device via the communication channel between the second transmission module and the first transmission module. The charging information mentioned herein is served as an information packet and then transmitted by various connection protocols of USB such as the connection point of the configuration channel included in the USB Type C interface or both ends of the USB transmission cable. That is to say, the charging device and the power receiving device transmit and receive the information packet via the configuration channel. The packet is performed by the protocol of the vender defined message (VDM). Compared with the design of the USB Type A or the USB Type B interface, the USB Type C interface is capable of directly performing the communication information in the hardware layer without transmitting the information to a higher level of software program. Consequently, a better-applied method of promoting the processing speed in operating while reducing the complex of the program design is achieved.

As stated in step S1d, after receiving the charging information associated with the current really passing through the battery charging circuit, the first transmission module determines whether the stop condition is satisfied. As mentioned in the foregoing embodiment of the system, the determination mechanism is disposed in the hardware device or the software program of the charging device. Take a computer host as an example, the determination mechanism is included in the charging determination program and activated when being charged. The charging determination program includes determining whether a calculation rule of the stop condition is satisfied. When the stop condition is unsatisfied, it performs the next step to adjust the output voltage and the current passing through the battery charging circuit to charge the mobile device. When the stop condition is satisfied, it is regarded that the optimal value has been achieved, and the adjusting of the output voltage is therefore stopped and the final adjusted charging voltage is maintained to continue charging the power receiving device. The stop condition mentioned herein means that the outputted charging voltage reaches to an output voltage safety value. And alternatively, the current passing through the battery charging circuit is not increased correspondingly after the charging voltage is boosted. The former is because an output voltage threshold value is provided to prevent the charging device boosting the output voltage unlimitedly, and the latter is to stop boosting the voltage according to the difference of the power receiving device when the charging current reaches to the maximum load. Those voltages are set in the charging determination program by the user, and alternatively, it can be disposed in the chip of the charging device in advance.

Finally, in step S1e, if the stop condition is unsatisfied, it compensates the output voltage control circuit of the charging device to adjust the charging voltage, so that the adjusted output voltage can be adjusted higher or lower. As a result, in order to avoid the voltage being adjusted overly to exceed in the loading of the transmission cable and the mobile device, it is firstly to adjust the voltage value having smaller range. Afterwards, when the variation of the current is confirmed, it is to gradually adjust the outputted charging voltage until the stop condition is satisfied.

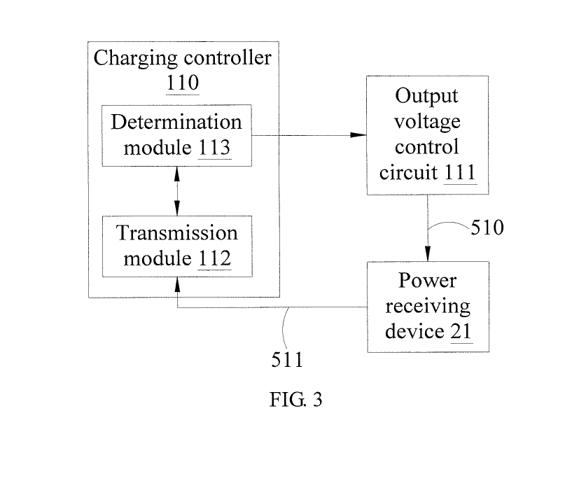

Please refer to FIG. 3 which is a schematic diagram of an embodiment of a charging controller of the present disclosure. As shown in the figure, a charging controller 110 is connected to an output voltage control circuit 111. The output voltage control circuit 111 is connected to the power receiving device 21 by the transmission cable, and the charging voltage outputted from the output voltage control circuit 111 charges the power receiving device 21 by a power channel 510 of the transmission cable. The charging controller 110 includes a transmission module 112 and a determination module 113. The transmission module 112 receives the charging information of the power receiving device 21 by the communication channel 511 of the transmission cable, and the determination module 113 determines whether the charging information is satisfied with the stop condition. If the stop condition is satisfied, the output voltage control circuit 111 is maintained to charge the power receiving device with the original charging voltage. If the stop condition is unsatisfied, the determination module 113 adjusts the charging voltage outputted from the output voltage control circuit 111, facilitating the power receiving device 20 to receive the charging voltage adequately. The determination module 113 mentioned herein may be a processor or implemented by a circuit and that applied in the foregoing embodiment both are capable of determining whether the charging information is satisfied with the stop condition. The charging information includes the voltage inputted to the power receiving device 21 or the current passing through the power receiving device 21, or the charging voltage of the charging device and any of them can be served as the standard for determining. The determination method is the same as that applied in the aforementioned embodiment, and the unnecessary details are no longer given herein.

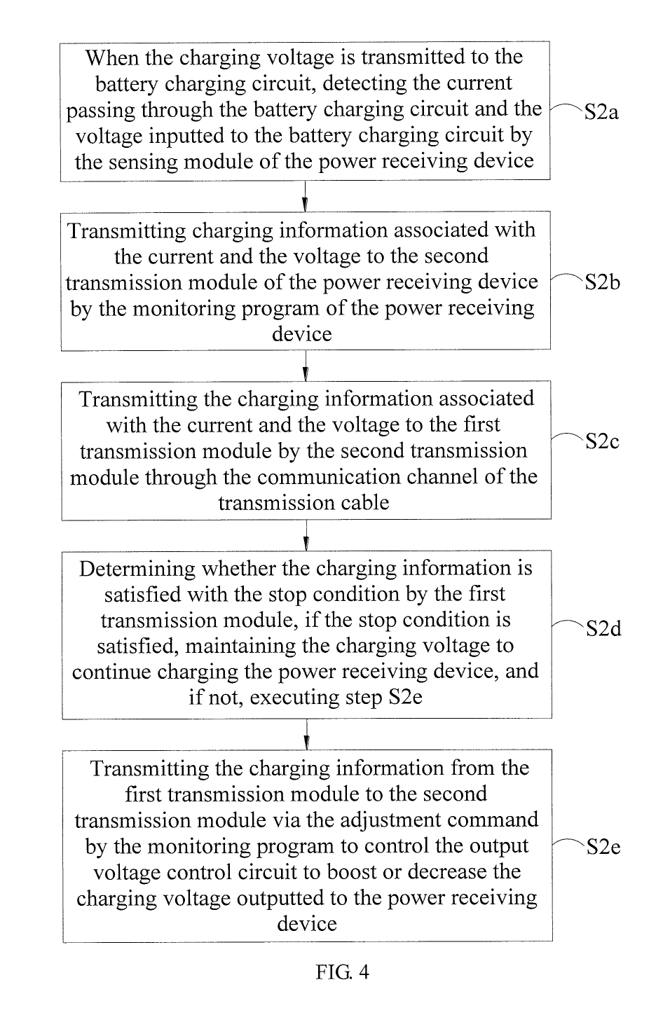

Please refer to FIG. 4 which is a flow chart of another embodiment of a charging method of the present disclosure. The charging method mentioned herein also adapts to the charging device and the power receiving device applied in the aforementioned embodiment. The power receiving device is connected to the charging device by the transmission cable. The first transmission module of the charging device controls the output voltage control circuit, and the output charging voltage charges the power receiving device. As shown in the figure, the charging method includes the following steps:

Step S2a: when the charging voltage is transmitted to the battery charging circuit, detecting the current passing through the battery charging circuit and the voltage inputted to the battery charging circuit by the sensing module of the power receiving device;

Step S2b: transmitting charging information associated with the current and the voltage to the second transmission module of the power receiving device by the monitoring program of the power receiving device;

Step S2c: transmitting the charging information associated with the current and the voltage to the first transmission module by the second transmission module through the communication channel of the transmission cable;

Step S2d: determining whether the charging information is satisfied with the stop condition by the first transmission module, if the stop condition is satisfied, maintaining the charging voltage to continue charging the power receiving device, and if not, executing step S2e; and

Step S2e: transmitting the charging information from the first transmission module to the second transmission module via the adjustment command by the monitoring program to control the output voltage control circuit to boost or decrease the charging voltage outputted to the power receiving device.

The above steps S2a, S2b, S2c, S2d, and S2e are similar to the steps applied in the aforementioned embodiment, and the unnecessary details are no longer given herein. The difference between the former embodiment and the present one lines that in step S2a to step S2e, and the practical information, which the sensing module senses, further includes the voltage actually inputted to the battery charging circuit. In addition to the current passing through the battery charging circuit, the voltage is also applied for determining the actual charging condition. As a consequence, once the power receiving device obtains the magnitude of the voltage, it can compare the voltage value with the variation of the original charging voltage to obtain the loss resulted from the impedance of the transmission cable, such that the charging voltage is boosted to compensate the loss. When the charging information associated with the voltage is served as the determination of the practical charging state, it can further limit the voltage by means of the stop condition of the determination mechanism. For example, when the actually input voltage is detected exceeding in the input voltage safety value, it stops to boost the output charging voltage of the charging device to avoid the voltage of the battery charging circuit exceeding in the loading.

Furthermore, in S2e, in addition to the charging voltage outputted manually, the present embodiment also enables the user to adjust the necessary charging voltage via the monitoring program according to the actual requirements. For example, when the voltage inputted to the battery charging circuit is detected being smaller than the output voltage safety value, the information associated with the voltage difference and the adjustable voltage magnitude shown in the charging device are applied to transform the desired output voltage into the adjustment command, and then the adjustment command is transmitted to the first transmission module by the second transmission module. The method simplifies the adjustment steps of the power receiving device, and only one manual adjustment can achieve the optimal charging state.

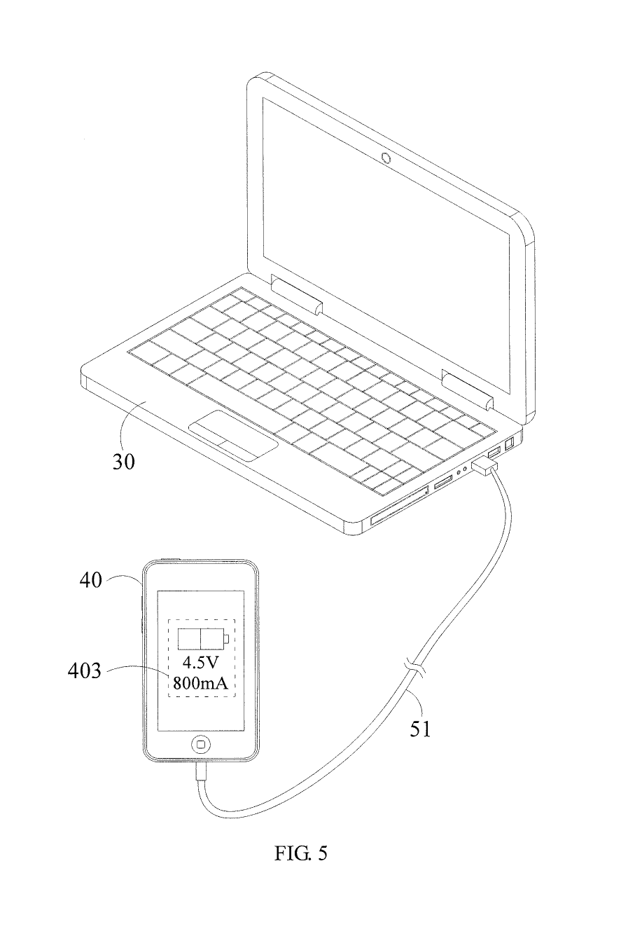

Please refer to FIG. 5 which is a schematic diagram of another embodiment of a charging system of the present disclosure. As shown in the figure, the charging system includes a notebook 30, a smartphone 40 and a USB transmission cable 51. The notebook 30 is disposed with a plurality of USB ports. Each USB port is provided for connecting to the USB transmission cable 51 and providing a 5V predetermined charging voltage and can be served as the charger of the smartphone 40. The smartphone 40 is connected to the notebook 30 through the USB transmission cable 51 so as to be charged through the provided 5V predetermined charging voltage. When the smartphone 40 and the notebook 50 connect to each other and start charging, an application (APP) 403 installed in the smartphone 40 applies a sensor built-in the smartphone 40 to obtain the input voltage and the passing current, which are respectively 4.5V and 800 mA. Next, the APP 403 displays the charging information on the screen of the smartphone 40 and transmits the charging information to the notebook 30 through the communication channel of the USB transmission cable 51 simultaneously. If the charging mechanism of the notebook 30 determines that the outputted charging voltage does not reach to the predetermined 5.2 V output voltage safety value, the predetermined charging voltage is boosted. For example, the 0.01V charging voltage boosts every time so that the current increases correspondingly. After boosting the charging voltage repeatedly, it returns to the step of detecting the actual passing current and the input voltage. When the output of the adjusting chagrining voltage reaches to 5.2V or the current passing through the battery charging circuit is not increased again, the boosting of the charging voltage is stopped and the power receiving device is charged with the final adjusted voltage as the optimal charging voltage. According to the actual test, if the original charging voltage value is 4.5V and the current value is 800 mA, when the charging voltage is adjusted to 5.1V, the current value is increased to 1100 mA correspondingly. Under the circumstances, the charging period of the smartphone 40 is shortened by about 30 minutes, and the convenience and usage of the phone is greatly promoted.

While the means of specific embodiments in present disclosure has been described by reference drawings, numerous modifications and variations could be made thereto by those skilled in the art without departing from the scope and spirit of the invention set forth in the claims. The modifications and variations should in a range limited by the specification of the present disclosure.

What is claimed is:

1. A charging method adapted to a charging device and a power receiving device, the power receiving device connected to the charging device by a transmission cable, and the charging device using a first transmission module to control an output voltage control circuit to output a charging voltage to charge the power receiving device through the transmission cable, the charging method comprising the following steps:
(a). when the charging voltage is transmitted to a battery charging circuit, detecting a current passing through the battery charging circuit by a sensor of the power receiving device;
(b). transmitting charging information associated with the current to a second transmission module of the power receiving device, by a monitoring program of the power receiving device;
(c). transmitting the charging information associated with the current to the first transmission module by the second transmission module through a communication channel of the transmission cable;
(d). determining whether the charging information is satisfied with a stop condition by the first transmission module, when the stop condition is satisfied, maintaining the charging voltage to continue charging the power receiving device, and if not, executing step (e); and
(e). adjusting the charging voltage outputted from the output voltage control circuit and returning to step (a) until the stop condition is satisfied.

2. The charging method of claim 1, wherein the stop condition means that the charging voltage outputted from the output voltage control circuit reaches to an output voltage safety value.

3. The charging method of claim 1, wherein the stop condition means that the current passing through the battery charging circuit is not increased correspondingly after the charging voltage is boosted.

4. The charging method of claim 1, wherein the sensor further senses a voltage inputted to the battery charging circuit, and information associated with the voltage is transmitted to the second transmission module by the monitoring program and to the first transmission module through the communication channel.

5. The charging method of claim 4, wherein the stop condition means that the voltage reaches to an input voltage safety value.

6. The charging method of claim 1, wherein the charging information is transmitted or received between the first transmission module and the second transmission module via a vender defined message packet.

7. A charging controller connected to an output voltage control circuit which is connected to a power receiving device through a transmission cable and configured to output a charging voltage to charge the power receiving device through the transmission cable, and the charging controller comprising:
a transmission module connected to the power receiving device by the transmission cable and configured to receive charging information transmitted from the power receiving device through a communication channel, and
a determination module connected to the transmission module, and configured to determine whether the charging information is satisfied with a stop condition, if the stop condition is satisfied, maintaining the charging voltage to continue charging the power receiving device, and if not, gradually adjusting the charging voltage outputted from the output voltage control circuit until the stop condition is satisfied.

8. The charging controller of claim 7, wherein the stop condition means that the charging voltage reaches to an output voltage safety value.

9. The charging controller of claim 7, wherein the charging information comprises a current passing through the power receiving device, and the stop condition means that the current passing through the power receiving device is not boosted correspondingly after the charging voltage is boosted.

10. The charging controller of claim 7, wherein the charging information comprises a voltage inputted to the power receiving device, and the stop condition means that the voltage reaches to an input voltage safety value.

11. A charging system, comprising:
a charging device comprising:
a first transmission module disposed in the charging device, and
an output voltage control circuit connected to the first transmission module, and the first transmission module configured to control the output voltage control circuit to provide a charging voltage, and
a power receiving device connected to the charging device through a transmission cable, comprising:
a battery charging circuit connected to the output voltage control circuit by the transmission cable and configured to receive the charging voltage to charge the power receiving device;
a sensor connected to the battery charging circuit, sensing a current passing through the battery charging circuit, and
a second transmission module disposed in the power receiving device and connected to the first transmission module by the transmission cable, and configured to transmit charging information associated with the current to the second transmission module by a monitoring program and to the first transmission module through a communication channel of the transmission cable;
wherein, the first transmission module determines whether the charging information is satisfied with a stop condition, if the stop condition is satisfied, the charging voltage is maintained to continue charging the power receiving device, and if not, the charging voltage outputted from the output voltage control circuit is gradually adjusted until the stop condition is satisfied.

12. The charging system of claim 11, wherein the stop condition means that the charging voltage reaches to an output voltage safety value.

13. The charging system of claim 11, wherein the stop condition means that the current passing through the battery charging circuit is not boosted correspondingly after the charging voltage is boosted.

14. The charging system of claim 11, wherein the sensor further senses a voltage inputted to the battery charging circuit and information associated with the voltage is transmitted to the second transmission module by the monitoring program and to the first transmission module through the communication channel.

15. The charging system of claim 14, wherein the stop condition means that the voltage reaches to an input voltage safety value.

16. The charging system of claim 11, wherein the charging information is transmitted or received between the first transmission module and the second transmission module via a vender defined message packet.
